(19) United States
(12) Patent Application Publication
(10) Pub. No.: US 2011/0003541 A1
(43) Pub. Date: Jan. 6, 2011

(54) SANDER

(75) Inventors: Hao Liu, Jiangsu (CN); Kenji Abe, Anjo-shi (JP); Shigeru Takeda, Anjo-shi (JP); Yuji Sakakibara, Anjo-shi (JP); Hirokazu Kimata, Anjo-shi (JP); Hideharu Muto, Anjo-shi (JP); Shin Nakamura, Anjo-shi (JP); Masanori Furusawa, Anjo-shi (JP); Yoshio Sugiyama, Anjo-shi (JP); Tomohiro Ukai, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, Anjo-Shi (JP)

(21) Appl. No.: 12/827,359

(22) Filed: Jun. 30, 2010

(30) Foreign Application Priority Data
Jul. 6, 2009 (JP) 2009-159862
Jan. 12, 2010 (JP) 2010-004009

(51) Int. Cl. B25F 5/02; B24B 23/02

(52) U.S. Cl. 451/359

(57) ABSTRACT

It is an object of the invention to improve usability of a movable handle, in a sander having the movable handle.

The sander includes a rotary working surface, a driving mechanism that is disposed above the rotary working surface in a direction of a rotation axis of the rotary working surface and rotationally drives the rotary working surface, a cylindrical housing that houses the driving mechanism, and a movable handle that is mounted on a surface of a cylindrical part of the cylindrical housing. The movable handle can be turned around a central axis of the cylindrical housing and can be fixed at an arbitrary position in a circumferential direction of the cylindrical housing.

### BACKGROUND OF THE INVENTION

1. Field of the Invention

The invention relates to a sander used for abrasive operation.

2. Description of the Related Art

Japanese laid-open patent publication No. 2004-167657 discloses a sander used for abrasive operation on a workpiece. According to the known sander, a grip as a main handle is integrally formed on an upper portion of a barrel of a housing which houses a driving mechanism.

In addition to this grip, the sander has a movable handle in the form of a side handle mounted on the barrel. The side handle includes a handle holder that is detachably mounted on the barrel of the housing, and a grip that can be linearly moved with respect to the handle holder in a horizontal (back-and-forth) direction transverse to the direction of the central axis of the barrel and can be fixed at an arbitrary position within a range of this movement. The orientation of the handle holder can be changed 180 degrees in the circumferential direction, so that the sander can serve both of left-handed and right-handed users.

While the side handle can be moved only linearly in the back-and-forth direction, more usability in this point is desired.

### SUMMARY OF THE INVENTION

It is, accordingly, an object of the invention to improve usability of a movable handle in a sander.

The above described object can be achieved by the claimed invention. In this respect, in a representative embodiment according to the invention, a sander is provided to include a rotary working surface, a driving mechanism, a cylindrical housing and a movable handle. The driving mechanism is disposed above the rotary working surface in a direction of a rotation axis of the rotary working surface and rotationally drives the rotary working surface. The cylindrical housing houses the driving mechanism. The movable handle is mounted on a surface of a cylindrical part of the cylindrical housing. The movable handle can be turned around a central axis of the cylindrical part of the cylindrical housing and can be fixed at an arbitrary position in a circumferential direction of the cylindrical part.

According to this invention, with the construction in which the movable handle can be fixed with respect to the cylindrical housing at an arbitrary position in the circumferential direction, the movable handle can be easily adjusted to a desired position according to the operation. Further, the user, left-handed or right-handed, can adjust the position of the movable handle with the movable handle held mounted on the cylindrical housing. Thus, a sander can be provided which can easily realize a suitable working posture for the user so that the working efficiency is effectively improved.

As another aspect of the invention, the sander may have a second handle which is provided in addition to the movable handle and can rotate with respect to the movable handle. The manner in which the second handle “can rotate with respect to the movable handle” suitably includes both the manner in which the second handle is fixed to the cylindrical housing and the manner in which the second handle is movable with respect to the cylindrical housing. According to this invention, when using the sander, the user can hold the movable handle and the second handle by both hands.

Further, as another aspect of the invention, the second handle may be a fixed handle immovably mounted on the cylindrical housing. According to this invention, the user can adjust the movable handle to a desired position with reference to the position of the fixed handle.

Further, according to another aspect of the invention, the movable handle may include a band wrapped around the surface of the cylindrical part of the cylindrical housing, a clamping part that clamps the band, a clamping operation part that is operated to clamp the clamping part and to release the clamping, and a grip to be held by user's hand. The clamping operation part is operated to clamp the clamping part and to release the clamping when the user holds the grip by hand and turns the grip around its longitudinal axis.

According to the invention, the clamping part can be clamped and the clamping can be released by user's simple operation of turning the grip. Therefore, adjustment of the fixed position of the movable handle with respect to the cylindrical housing can be simply and easily made, so that the workability can be improved.

Other objects, features and advantages of the present invention will be readily understood after reading the following detailed description together with the accompanying drawings and the claims.

### BRIEF DESCRIPTION OF THE DRAWINGS

FIG. 1 is a side view showing a sander having a movable handle as a side handle according to a first embodiment of the invention.

FIG. 2 is a plan view of the sander.

FIG. 3 is a sectional plan view of the side handle.

FIG. 4 is a sectional side view showing a sander having a movable handle in the form of a side handle according to a second embodiment of the invention.

FIG. 5 is a sectional plan view of the side handle.

FIG. 6 is a sectional side view showing a sander having a movable handle as a side handle according to a third embodiment of the invention.

FIG. 7 is a sectional plan view of the side handle.

FIG. 8 is a cutaway side view showing a sander having a movable handle as a side handle according to a fourth embodiment of the invention.

FIG. 9 is a sectional view taken along line A-A of FIG. 8.

FIG. 10 is a sectional view taken along line B-B of FIG. 9.

FIG. 11 is a cutaway side view showing a sander having a movable handle as a side handle according to a fifth embodiment of the invention, in a cam engaged state.

FIG. 12 is a cutaway side view showing the sander, in a cam disengaged state.

FIG. 13 is a sectional view taken along line C-C of FIG. 11.

FIG. 14 is a sectional side view showing a sander having a movable handle as a side handle according to a sixth embodiment of the invention.

FIG. 15 is a sectional view taken along line D-D of FIG. 14.

FIG. 16 is a sectional side view showing a sander having a movable handle as a side handle according to a seventh embodiment of the invention.

FIG. 17 is a sectional view taken along line E-E of FIG. 16.

FIG. 18 is a sectional side view showing a sander having a movable handle as a side handle according to an eighth embodiment of the invention.

FIG. 19 is a partly enlarged view of FIG. 18.

### DETAILED DESCRIPTION OF THE INVENTION

Each of the additional features and method steps disclosed above and below may be utilized separately or in conjunction with other features and method steps to provide and manufacture improved sanders and method for using such sanders and devices utilized therein. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

### First Embodiment

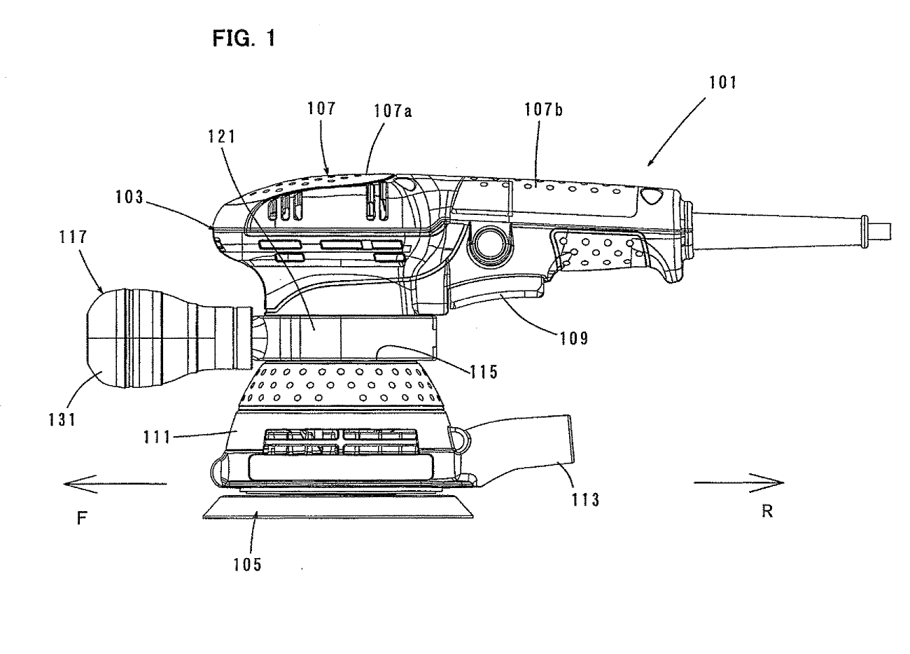

A first embodiment of the invention is now described with reference to FIGS. 1 to 3. As shown in FIG. 1, a sander 101 according to this embodiment mainly includes a motor (not shown), a generally cylindrical motor housing 103 that houses the motor and a power transmitting mechanism (not shown), and an abrasive part 105 disposed on the lower end of the motor housing 103 in its longitudinal direction (vertical direction as viewed in FIG. 1) and protruding downward from the motor housing 103. The motor housing 103 forms a tool body and is a feature that corresponds to the “cylindrical housing” according to this invention. The power transmitting mechanism serves to reduce the speed of the rotating power of the motor and transmit it to the abrasive part 105 and is a feature that corresponds to the “driving mechanism” according to this invention. For the sake of convenience of explanation, in FIG. 1, the direction of the arrow F is taken as the front and the direction of the arrow R is taken as the rear.

The abrasive part 105 includes a generally circular abrasive plate disposed below the motor housing 103. An abrasive sheet (sandpaper) or the like is removably attached on a lower surface of the abrasive plate and forms an abrasive surface. The abrasive surface of the abrasive part 105 is a feature that corresponds to the “rotational working surface” according to this invention. The abrasive plate of the abrasive part 105 is rotatably supported at an eccentric position displaced from an output shaft of the power transmitting mechanism and driven by the motor via the power transmitting mechanism to perform eccentric motion and rotational motion. Therefore, the abrasive part 105 is driven with the abrasive surface of the abrasive part 105 pressed against the workpiece, so that a workpiece can be ground or polished by the abrasive surface. The driving structure for causing the eccentric motion and rotational motion of the abrasive part 105 is known and therefor it is not described in further detail.

The motor housing 103 is generally cylindrical, and a grip 107 which can be held by user's hand is formed in an upper region of the cylindrical part. The grip 107 according to this embodiment includes a first grip part 107a and a second grip part 107b. The first grip part 107a is generally elliptical in plan view and designed to be held by the user in such a manner as to be wrapped in (pressed down) from above in the user's entire palm. The second grip part 107b is generally cylindrical and extends contiguously to the first grip part 107a and horizontally in a rearward direction. The grip 107 is a feature that corresponds to the “second handle” and “fixed handle” according to this invention. A trigger switch 109 is disposed on the underside of the contiguous region between the first grip part 107a and the second grip part 107b and depressed by user's finger to start the motor. Thus the trigger switch 109 is disposed in a base region of the second grip part 107b contiguous to the first grip part 107a, or between the grip parts 107a and 107b. Therefore, the trigger switch 109 is located close to both of the grip parts 107a and 107b, so that it can be easily operated whether the user holds the first grip part 107a or the second grip part 107b.

A lower region of the cylindrical part of the motor housing 103 is provided as a lower housing 111 having not only the function of housing the power transmitting mechanism and rotatably supporting the abrasive part 105, but a dust collecting function. The lower housing 111 has a dust collecting passage for collecting dust which is generated by abrasive operation of the abrasive part 105. Further, a dust discharge nozzle 113 is provided in the lower housing 111 and a dust collecting bag is attached to the dust discharge nozzle 113 so that dust is collected in the bag.

A handle mounting part 115 for mounting a side handle 117 is formed in a middle region of the cylindrical part of the motor housing 103 or on an outer circumferential surface of the motor housing 103 between the grip 107 and the lower housing 111. The handle mounting part 115 is provided as a circular recessed portion having a smaller diameter than the other regions around a central axis of the motor housing 103.

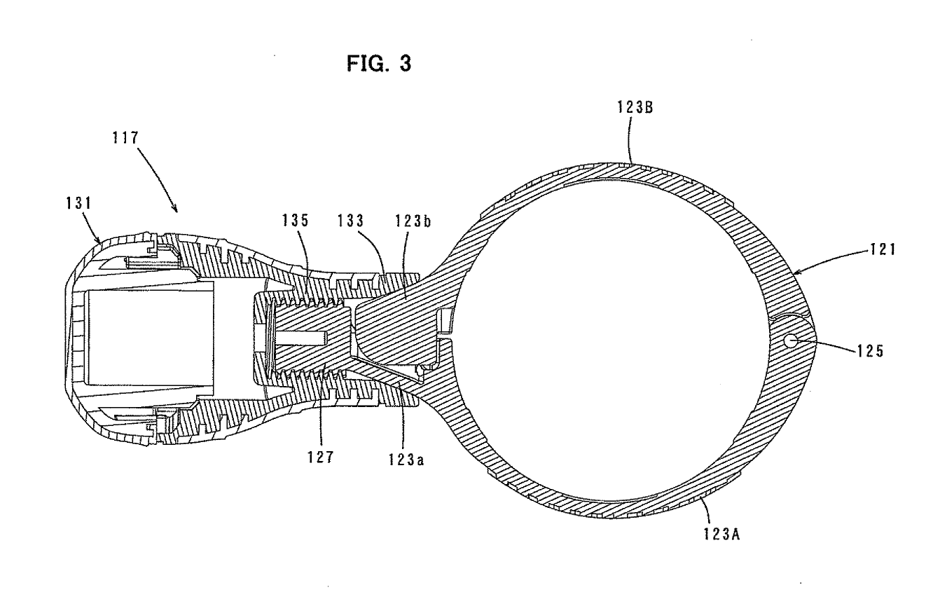

The side handle 117 is detachably mounted to the handle mounting part 115. The side handle 117 is a feature that corresponds to the “movable handle” according to this invention. As shown in FIG. 3, the side handle 117 mainly includes a mounting band 121 detachably mounted to the handle mounting part 115, and a grip part 131 to be held by the user. The mounting band 121 and the grip part 131 are features that correspond to the “band” and the “grip”, respectively, according to this invention.

The mounting band 121 includes a pair of semicircular arc band components 123A, 123B which are opposed to each other and form a ring-like shape. One end of each of the band components 123A, 123B is connected to one end of the other via a pin 125 such that the band components 123A, 123B can be opened and closed (pivot with respect to each other). The other end of each of the band components 123A, 123B is a free end. Therefore, the mounting band 121 can be wrapped around the handle mounting part 115 by turning the band components 123A, 123B inward on the pin 125 so as to close them, while the mounting band 121 can be detached from the handle mounting part 115 by opening the band components outward.

The grip part 131 is generally shaped like an eggplant. One end of the grip part 131 in the longitudinal direction is connected to the free end of the mounting band 121 such that the mounting band 121 can be tightened and loosened around the handle mounting part 115 by turning the grip part 131 around its longitudinal axis with the mounting band 121 wrapped around the handle mounting part 115. The structure of connecting the grip part 131 and the mounting band 121 is now explained below.

The grip part 131 has a hollow hole open on the side of connection with the mounting band 121 and extending in the longitudinal direction. A clamping tapered hole 133 tapered toward the depth of the hole is formed in the open end region of the hollow hole. Further, a female threaded part (threaded hole) 135 for clamping operation is formed at the back of the clamping tapered hole 133 in the hollow hole. Bases 123a, 123b are formed on the free ends of the band components 123A, 123B of the mounting band 121, respectively, and extend outward therefrom. Each of the bases 123a, 123b has a semicircular outer surface tapered toward the extending end. Therefore, when the mounting band 121 is closed, the bases 123a, 123b are opposed to each other so that the outer surfaces of the bases form a circular tapered surface. In this opposed state, the bases 123a, 123b are fitted in the clamping tapered hole 133 of the grip part 131.

Further, a male threaded part 127 for clamping operation is formed on one base 123a and extends from the extending end of the base 123a. The male threaded part 127 is threadably engaged with the female threaded part 135 of the grip part 131. Therefore, when the grip part 131 is turned, the male threaded part 127 and the female threaded part 135 turn with respect to each other, so that the grip part 131 and the mounting band 121 move toward or away from each other in the longitudinal direction according to the turning direction of the grip part 131. By this relative movement, the bases 123a, 123b fitted in the clamping tapered hole 133 are clamped by the clamping tapered hole 133, or released from the clamping. Therefore, the mounting band 121 is tightened in a direction that reduces its diameter, or it is loosened. The clamping tapered hole 133 and the bases 123a, 123b form the “clamping part” according to this invention, and the female threaded part 135 and the male threaded part 127 form the “clamping operation part” according to this invention.

The one base 123a contiguously connected to the male threaded part 127 has a generally semicircular arc section so as to ensure a predetermined strength and to avoid interference with the other base 123b.

The sander 101 according to this embodiment is constructed as described above, and its usage is now explained. When the motor is driven by operating the trigger switch 109, the abrasive part 105 performs eccentric motion and rotational motion. A predetermined abrasive operation can be performed on a workpiece by pressing the abrasive part 105 against the workpiece.

In performing the above-described abrasive operation with the sander 101 according to this embodiment, the position of the side handle 117 (the position of the grip part 131) can be arbitrarily changed. Specifically, in order to loosen the mounting band 121 tightly wrapped around the handle mounting part 115 and allow the mounting band 121 to be turned around the handle mounting part, the grip part 131 is turned in a direction that moves away from the mounting band 121 so that the clamping of the bases 123a, 123b by the clamping tapered hole 133 is released. Therefore, in this state, the position of the side handle 117 can be arbitrarily changed by turning the side handle 117 around the central axis of the motor housing 103. Further, after such positional change, the mounting band 121 can be securely fixed to the handle mounting part 115 by turning the grip part 131 in the opposite direction.

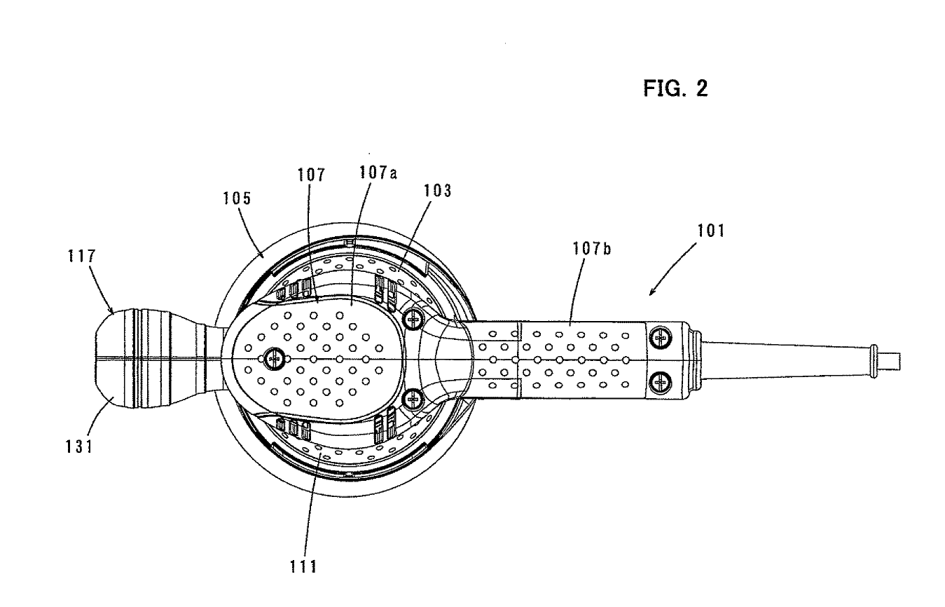

As described above, according to this embodiment, the side handle 117 can be easily adjusted steplessly to a desired position by turning the side handle 117 in a horizontal direction around the central axis of the motor housing 103. The side handle 117 mounted on the motor housing 103 can be adjusted in position within the range of 360 degrees. Therefore, the side handle 117 can be easily adjusted whether the user is left-handed or right-handed. Further, as shown in FIGS. 1 and 2, the side handle 117 can also be placed in a front position to be opposed to the rear second grip part 107b of the grip 107. Thus, according to this embodiment, the sander 101 can be provided which can easily realize a suitable working posture for the user so that the working efficiency is effectively improved.

Further, in this embodiment, the mounting band 121 is tightened and loosened around the handle mounting part 115 of the motor housing 103 by turning the grip part 131. In other words, the grip part 131 also serves as an operating member which is operated to tighten and loosen the mounting band 121. Thus, the number of components of the side handle 117 can be reduced.

Further, the side handle 117 according to this embodiment is constructed such that the grip part 131 and the mounting band 121 are connected to each other by a threaded structure. The length of threadable engagement between the male threaded part 127 and the female threaded part 135 is set such that the threadable engagement is maintained even if the base 123b not having the male threaded part 127 is detached from the clamping tapered hole 133 of the grip part 131. Therefore, the grip part 131 and the mounting band 121 can be avoided from being separated from each other even if the side handle 117 is detached from the motor housing 103.

Further, in this embodiment, each of the bases 123a, 123b of the band components 123A, 123B has a tapered outer surface, and the bases 123a, 123b are clamped by the clamping tapered hole 133 of the grip part 131. Therefore, the mounting band 121 can be securely fixed to the handle mounting part 115 by the wedge action of the tapered engagement surfaces of the clamping tapered hole 133 and the bases 123a, 123b.

### Second Embodiment

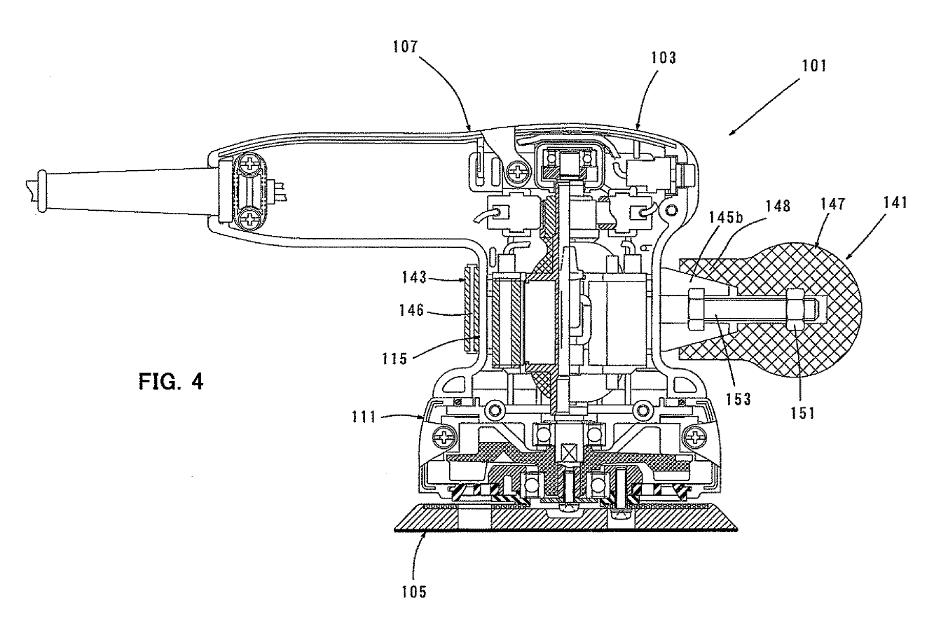

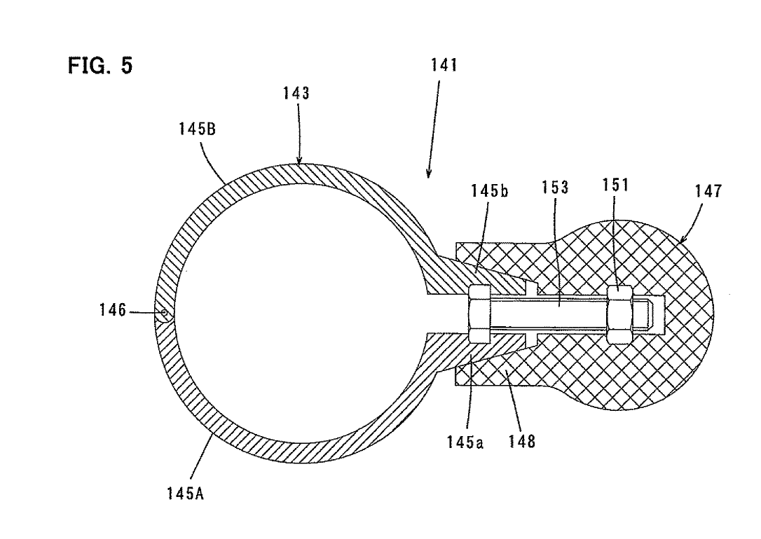

Now, a side handle according to a second embodiment of the invention is described with reference to FIGS. 4 and 5. The entire structure of the sander 101 to which the side handle is attached is not particularly changed from the first embodiment, and therefore, its components are given like numerals as in the first embodiment and will not be described or will be only briefly described. The same goes for not only the second embodiment, but third and later embodiments.

A side handle 141 according to this embodiment mainly includes a ring-like mounting band 143 which is wrapped around the handle mounting part 115 formed on the motor housing 103 of the sander 101, and a grip part 147 to be held by a user. The side handle 141, the mounting band 143 and the grip part 147 are features that correspond to the “movable handle”, the “band” and the “grip”, respectively, according to this invention.

As shown in FIG. 5, the mounting band 143 includes a pair of semicircular arc band components 145A, 145B which are opposed to each other and form a ring-like shape. One end of each of the are band components 145A, 145B is connected to one end of the other via a pin 146 such that the band components 145A, 145B can be opened and closed (pivot with respect to each other). The other end of each of the band components 145A, 145B is a free end. Therefore, the mounting band 143 can be wrapped around the handle mounting part 115 by turning the band components 145A, 145B inward on the pin 146 so as to close them, while the mounting band 143 can be detached from the handle mounting part 115 by opening the band components outward.

The grip part 147 is disposed on the outside of the mounting band 143 such that its central axis lies on a straight line passing through the center of mounting band 143 in a radial direction. One end of the grip part 147 in the longitudinal direction is connected to the free end of the mounting band 143 such that the mounting band 143 can be tightened and loosened around the handle mounting part 115 by turning the grip part 147 around its longitudinal axis with the mounting band 143 wrapped around the handle mounting part 115. The structure of connecting the grip part 147 and the mounting band 143 is now explained below.

The grip part 147 is generally shaped like an eggplant. A clamping tapered hole 148 tapered toward the depth of the hole is formed on one end of the grip part 147 in its longitudinal direction. Bases 145a, 145b are formed on the free ends of the band components 145A, 145B of the mounting band 143, respectively, and extend radially outward therefrom. Each of the bases 145a, 145b has a semicircular outer surface tapered toward the extending end. Therefore, when the mounting band 143 is closed, the bases 145a, 145b are opposed to each other so that the outer surfaces of the bases form a circular tapered surface. In this opposed state, the bases 145a, 145b are fitted in the clamping tapered hole 148 of the grip part 147.

Further, a nut 151 is disposed within the grip part 147 in such a manner as to be prevented from moving in the axial and circumferential directions. The nut 151 can be fixedly disposed within the grip part 147, for example, by forming the grip part 147 by two halves connected together, or by insert molding in the process of forming the grip part 147. Further, a bolt 153 is disposed between the bases 145a, 145b of the band components 145A, 145B and locked against rotation by the bases 145a, 145b. The bolt 153 is inserted into the central hole of the grip part 147 in the longitudinal direction and threadably engaged with the nut 151. The clamping tapered hole 148 and the bases 145a, 145b form the “clamping part” according to this invention, and the nut 151 and the bolt 153 form the “clamping operation part” according to this invention.

The side handle 141 according to this embodiment is constructed as described above. Therefore, when the grip part 147 is turned in one direction (for example, clockwise), the grip part 147 moves in a direction toward the mounting band 143 by relative rotation of the nut 151 and the bolt 153 in the longitudinal direction. As a result, the bases 145a, 145b are clamped by the clamping tapered hole 148, so that the mounting band 143 is contracted and clamped on the handle mounting part 115. When the grip part 147 is turned in the other direction, the grip part 147 moves in a direction away from the mounting band 143 by relative rotation of the nut 151 and the bolt 153 in the longitudinal direction. As a result, the clamping of the bases 145a, 145b by the clamping tapered hole 148 is released, so that the mounting band 143 is expanded and released from the clamping on the handle mounting part 115.

When the mounting band 121 tightly wrapped around the handle mounting part 115 is loosened, the mounting band 121 is allowed to be turned around the handle mounting part. Therefore, in this state, the position of the side handle 141 (the position of the grip part 147) can be arbitrarily changed by turning the side handle 141 around the central axis of the motor housing 103. Further, after such positional change, the side handle 141 can be securely fixed to the handle mounting part 115 by tightening the mounting band 143.

Thus, according to this embodiment, the same effects as the above-described first embodiment can be obtained. For example, the side handle 141 can be easily adjusted to a desired position according to the operation. Further, particularly, the structure of tightening the mounting band 143 is simply constructed by using the bolt 153 and the nut 151, so that the sander is easy to manufacture and reduced in cost.

### Third Embodiment

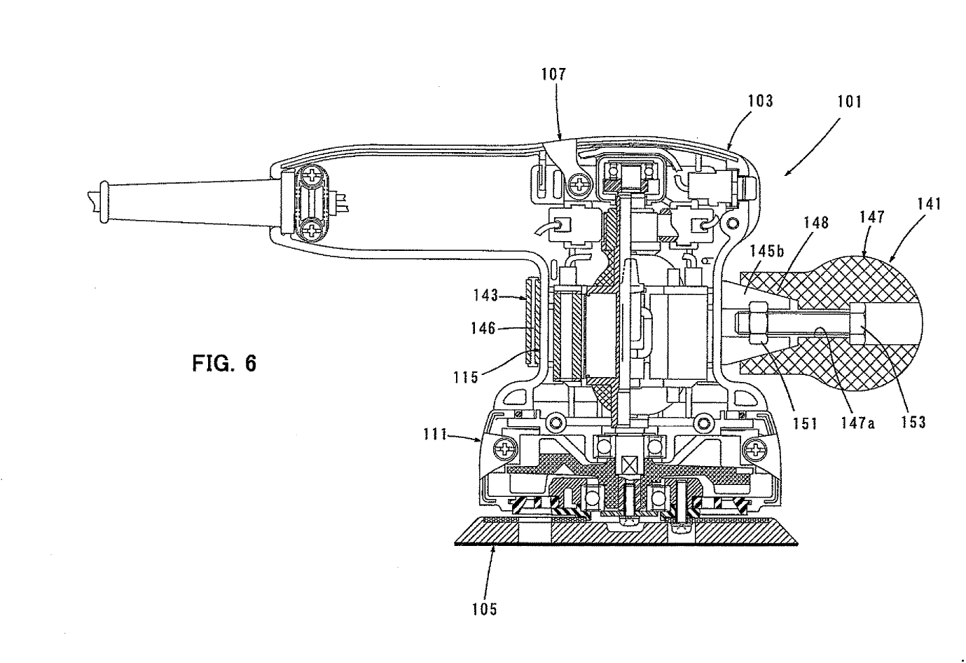

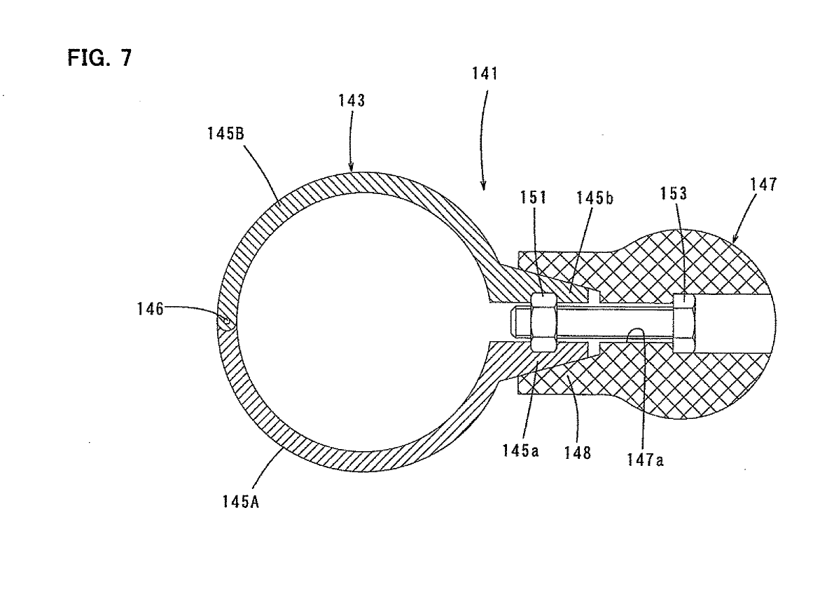

Now, a third embodiment of the invention is described with reference to FIGS. 6 and 7. This embodiment is a modification to the above-described side handle 141 of the second embodiment. In this embodiment, in the side handle 141, the nut 151 is disposed between the bases 145a, 145b of the mounting band 143, and the bolt 153 is disposed in the grip part 147. In the other points, this embodiment is similarly constructed as the second embodiment. As shown in the drawings, a stepped through hole 147a having a hexagonal hole is centrally formed through the grip part 147, and the bolt 153 is inserted into the stepped through hole 147a and locked against rotation. In this state, the bolt 153 is threadably engaged with the nut 151. Alternatively, the bolt 153 may be formed by insert molding in the grip part 147.

According to the third embodiment thus constructed, the same effects as the second embodiment can be obtained.

### Fourth Embodiment

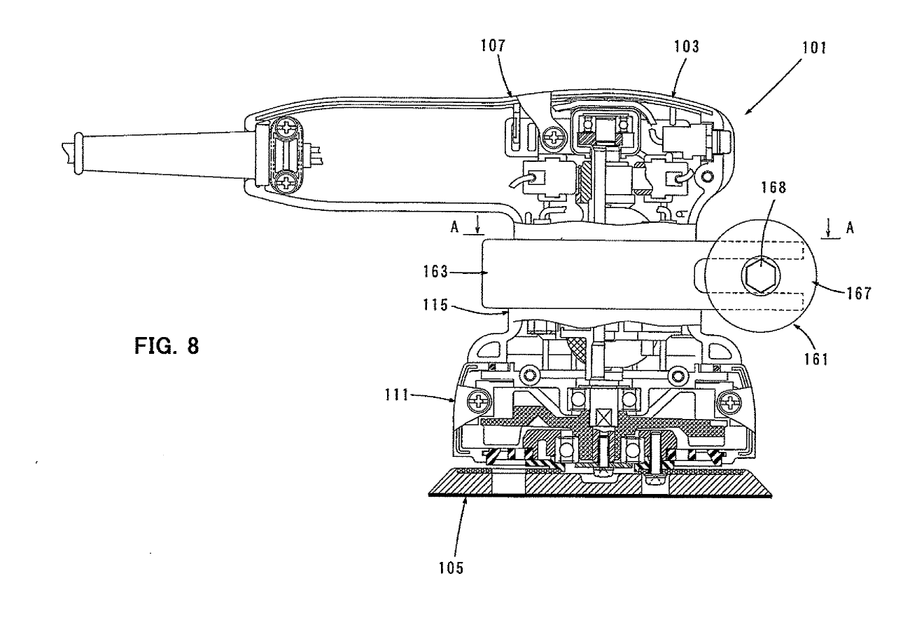

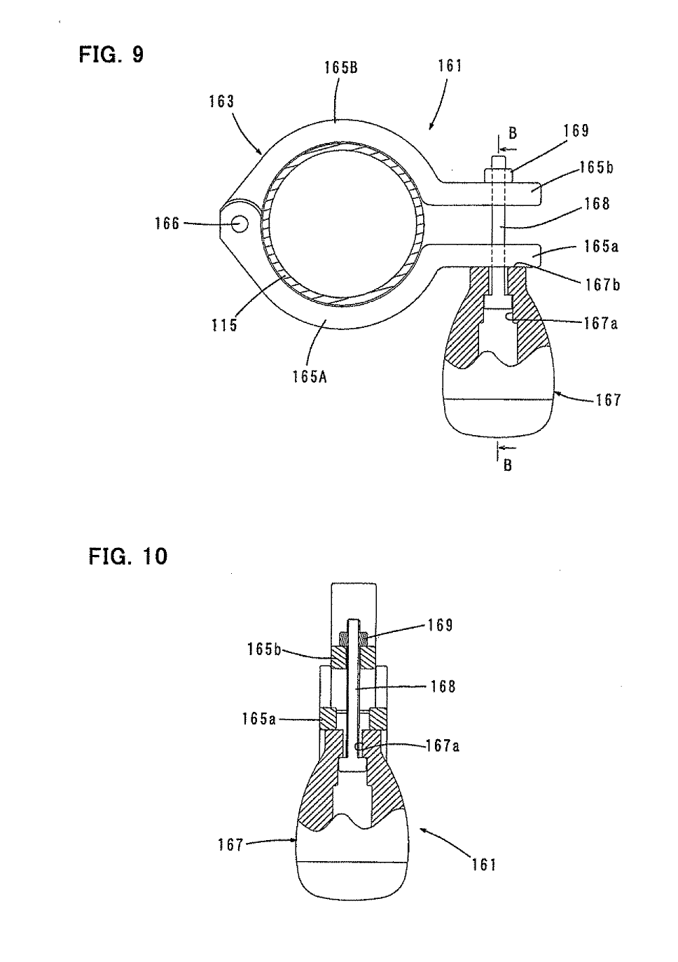

Now, a side handle according to a fourth embodiment of the invention is described with reference to FIGS. 8 to 10. A side handle 161 according to this embodiment mainly includes a ring-like mounting band 163 which is wrapped around the handle mounting part 115 formed on the motor housing 103 of the sander 101, and a grip part 167 to be held by a user. The side handle 161, the mounting band 163 and the grip part 167 are features that correspond to the “movable handle”, the “band” and the “grip”, respectively, according to this invention.

The mounting band 163 includes a pair of semicircular arc band components 165A, 165B which are opposed to each other and form a ring-like shape. One end of each of the semicircular arc band components 165A, 165E is connected to one end of the other via a pin 166 such that the band components 165A, 165B can be opened and closed (pivot with respect to each other). The other end of each of the band components 165A, 165B is a free end. Plate-like bases 165a, 165b are formed on the free ends such that the bases are opposed to each other with a predetermined spacing and extend radially outward from the free ends. The mounting band 163 can be wrapped around the handle mounting part 115 by turning the band components 165A, 165B inward on the pin 166 so as to close them, while the mounting band 163 can be detached from the handle mounting part 115 by opening the band components outward.

The grip part 167 is disposed on the outside of the mounting band 163 such that its central axis extends in a direction transverse to the extending direction of the bases 165a, 165b of the mounting band 163. The grip part 167 is generally shaped like an eggplant and has a bolt 168 protruding in its longitudinal direction through one end surface 167b in the longitudinal direction. The bolt 168 is loosely fitted and extends through the bases 165a, 165b, and a nut 169 is threadably mounted on an extending end of the bolt 168. A stepped through hole 167a having a hexagonal hole is centrally formed through the grip part 167, and the bolt 168 is inserted into the stepped through hole 167a and locked against rotation. Alternatively, the bolt 168 may be formed by insert molding in the grip part 167.

The side handle 161 according to this embodiment is constructed as described above. Therefore, when the grip part 167 is turned in one direction (for example, clockwise), the bases 165a, 165b of the band components 165A, 165B are clamped between the nut 169 and the end surface 167b of the grip part 167 by relative rotation of the bolt 168 and the nut 169 in the longitudinal direction. As a result, the mounting band 163 is contracted and clamped on the handle mounting part 115. When the grip part 167 is turned in the other direction, the clamping of the bases 165a, 165b between the nut 169 and the end surface 167b of the grip part 167 by relative rotation of the bolt 168 and the nut 169 in the longitudinal direction is released. Thus, the mounting band 163 is expanded and released from the clamping on the handle mounting part 115. The bolt 168 and the nut 169 form the “clamping part” according to this invention.

According to this embodiment, substantially the same effects as the above-described first embodiment can be obtained. For example, the side handle 161 (the grip part 167) can be easily adjusted to a desired position according to the operation. Further, particularly, the structure of tightening the mounting band 163 is simply constructed by using the bolt 168 and the nut 169, so that the sander is easy to manufacture and reduced in cost. Further, although, in this embodiment, the bolt 168 is fixed to the grip part 167, not the bolt 168 but the nut 169 may be fixed to the grip part 167.

### Fifth Embodiment

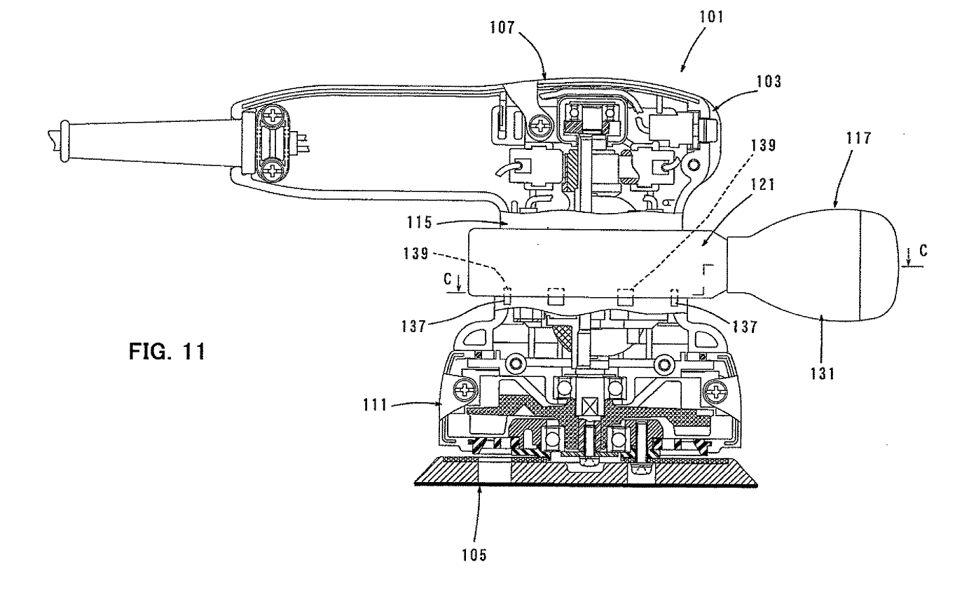

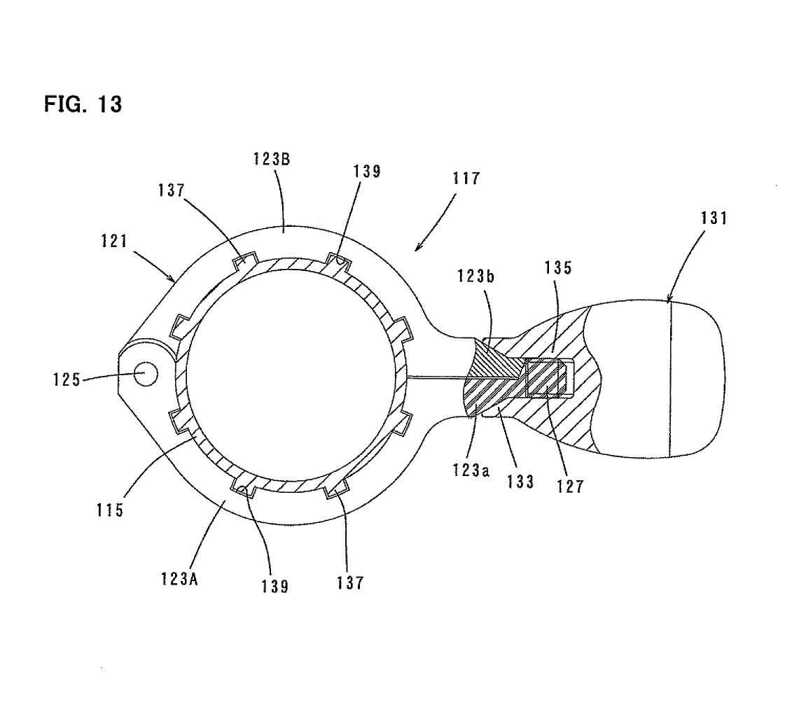

Now, a side handle according to a fifth embodiment of the invention is described with reference to FIGS. 11 to 13. The side handle of this embodiment is different from the side handle 117 of the first embodiment in that recesses 139 are formed in the inner circumferential surface of the side handle 117 of the first embodiment and can be engaged with projections 137 formed on the handle mounting part 115 of the motor housing 103. In the other points, it has the same construction. Therefore, the entire structure of the side handle 117 is given like numerals as in the first embodiment and will not be described or will be only briefly described.

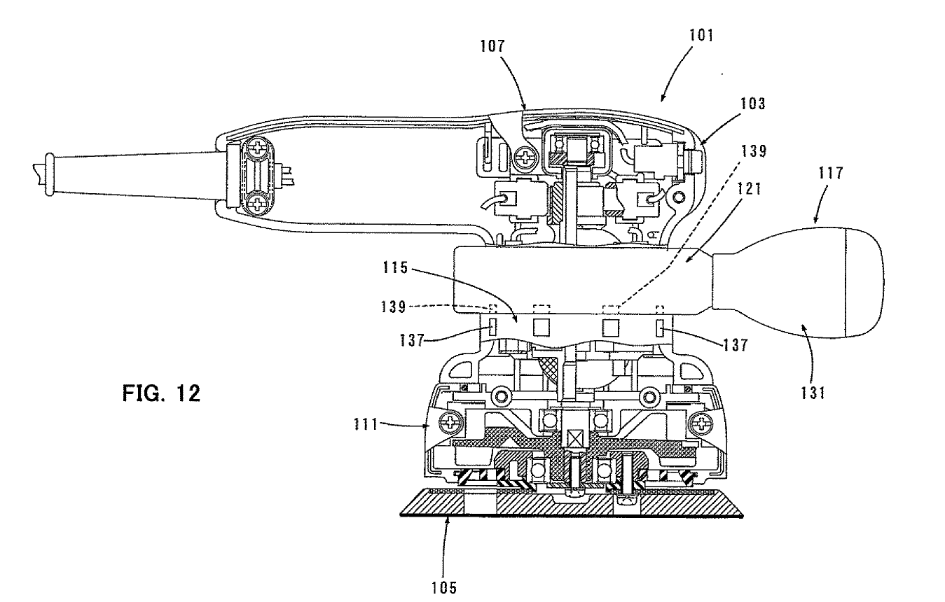

A plurality of (eight in this embodiment) projections 137 having a rectangular section in plan view and having a predetermined length extending in the longitudinal direction of the motor housing 103 (the vertical direction) are formed on the outer circumferential surface of the handle mounting part 115 and spaced equidistantly in the circumferential direction. As shown in FIGS. 11 and 12, the projections 137 are disposed on a lower portion of the handle mounting part 115. A plurality of recesses 139 each having an open lower end are formed in the inner circumferential surface of a lower portion of the band components 123A, 123B of the mounting band 121 and spaced like the projections 137 in the circumferential direction. When released from the clamping on the handle mounting part 115, the mounting band 121 is allowed to slide in the longitudinal direction (the vertical direction) with respect to the handle mounting part 115. At this time, when the mounting band 121 is moved downward, the recesses 139 are engaged with the projections 137, and when the mounting band 121 is moved upward, this engagement is released. Specifically, the side handle 117 is allowed to slide between the engagement position in which the projections 137 and the recesses 139 are engaged with each other and the disengagement position in which the engagement is released.

The side handle 117 according to this embodiment is constructed as described above. Therefore, in order to change the position of the side handle 117 (the position of the grip part 131), the mounting band 121 is released from the clamping on the handle mounting part 115 by turning the grip part 131 around the longitudinal axis of the grip part 131, and then, as shown in FIG. 12, the whole side handle 117 is slid upward such that the recesses 139 are disengaged from the projections 137 of the handle mounting part 115. Thus, the engagement of the recesses 139 with the projections 137 can be released. Subsequently, the side handle 117 is moved to a desired position in the circumferential direction with respect to the handle mounting part 115 and slid downward such that the recesses 139 are engaged with the protrusions 137. Thereafter, by turning the grip part 131, the mounting band 121 is tightened and fixedly mounted on the handle mounting part 115.

In this embodiment, eight projections 137 and eight recesses 139 are provided. Therefore, the position of the grip part 131 can be changed in 45-degree increments in the circumferential direction around the central axis of the handle mounting part 115.

According to this embodiment, substantially the same effects as the above-described first embodiment can be obtained. For example, the position of the side handle 117 (the position of the grip part 131) can be easily adjusted to a desired position according to the operation. Further, particularly in this embodiment, by engagement of the projections 137 and the recesses 139, the side handle 117 clamped on the handle mounting part 115 can be provided with a stronger resistance to relative movement in the circumferential direction.

Further, in this embodiment, the position of the side handle 117 is described as being changed in 45-degree increments, but the increments can be appropriately changed by changing the numbers of the projections 137 and the recesses 139. Further, in this embodiment, the projections 137 are formed on the handle mounting part 115 side (the motor housing 103 side) and the recesses 139 are formed on the side handle 117 side, but the recesses 139 may be formed on the handle mounting part 115 side and the projections 137 may be formed on the side handle 117 side.

### Sixth Embodiment

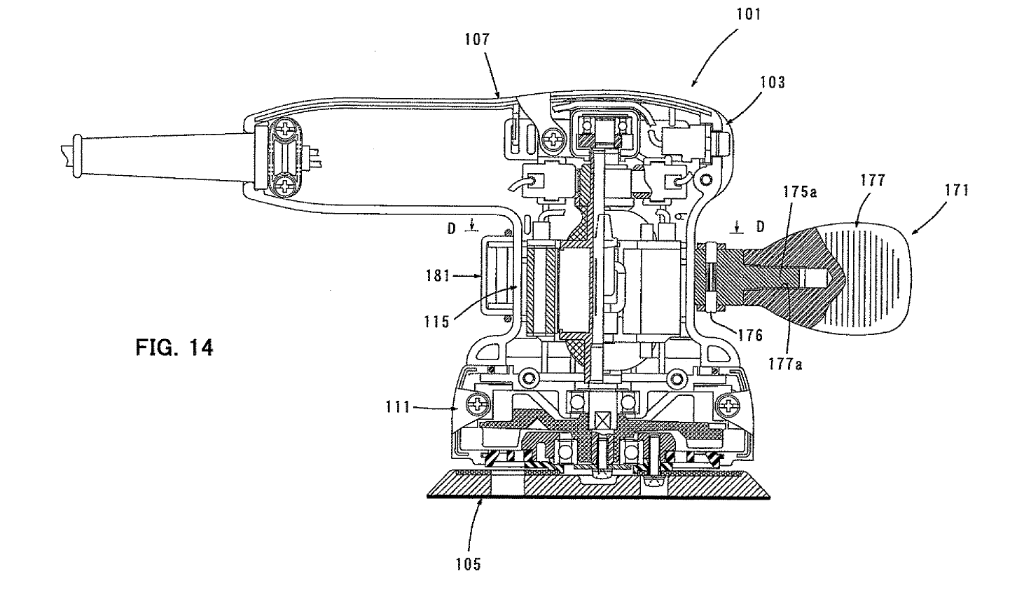

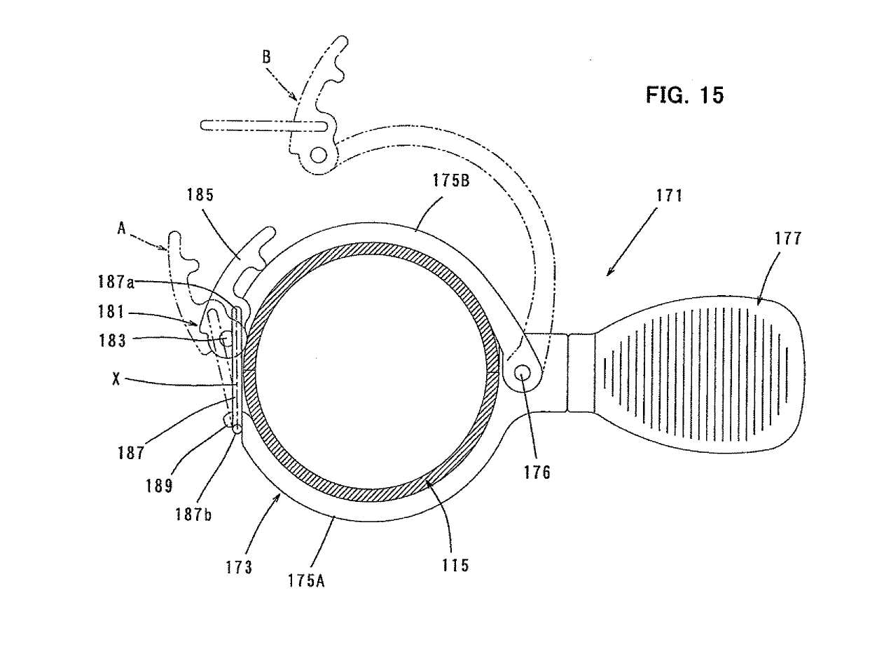

Now, a side handle according to a sixth embodiment of the invention is described with reference to FIGS. 14 and 15. A side handle 171 according to this embodiment mainly includes a ring-like mounting band 173 which is wrapped around the handle mounting part 115 of the motor housing 103, and a grip part 177 to be held by a user. The side handle 171, the mounting band 173 and the grip part 177 are features that correspond to the “movable handle”, the “band” and the “grip”, respectively, according to this invention.

The mounting band 173 includes a pair of semicircular arc band components 175A, 175B which are opposed to each other and form a ring-like shape. One end of each of the semicircular arc band components 175A, 175B is connected to one end of the other via a pin 176 such that the band components 175A, 175B can be opened and closed (pivot with respect to each other). The other end of each of the band components 175A, 175B is a free end, and a band fastener 181 which will be described below is mounted on the free end. The band fastener 181 is a feature that corresponds to the “band fastener” according to this invention. The mounting band 173 has a radially outwardly protruding threaded shaft 175a formed on the end of the one band component 175A on the side of the connection between the band components 175A, 175B by the pin 176.

The grip part 177 is generally shaped like an eggplant and has a threaded hole 177a extending from one end in its longitudinal direction. The grip part 177 is connected to the mounting band 173 by threadably engaging the threaded hole 177a with the threaded shaft 175a of the mounting band 173. Specifically, the grip part 177 is arranged such that its central axis lies on a straight line radially passing through the center of the mounting band 173 and the grip part 177 is integrally formed with the mounting band 173.

The band fastener 181 mainly includes an operating lever 185 mounted on the free end of the other band component 175B which does not have the threaded shaft 175a, and a generally rectangular hook ring 187 connected to the operating lever 185. The operating lever 185 and the hook ring 187 are features that correspond to the “operating member” and the “hook member”, respectively, according to this invention. The operating lever 185 can be turned around a shaft 183 which is parallel to the pin 176. The hook ring 187 is connected to the operating lever 185 such that the hook ring 187 can rotate around a pivot which is parallel to the shaft 183. A front end of the hook ring 187 on the side opposite from the pivot can be engaged with and disengaged from a hook 189 which is formed on the free end of the other band component 175A.

The side handle 171 according to this embodiment is constructed as described above. The mounting band 173 is wrapped around the handle mounting part 115 and the front end of the hook ring 187 is engaged with an engagement part in the form of the hook 189 (as shown by two-dot chain line A in FIG. 15). At this time, a pivot of the operating lever 185 (the shaft 183) lies on the outside of a straight line X connecting a point (pivot) 187a of connection of the hook ring 187 with the operating lever 185 and a point 187b of engagement of the hook ring 187 with the hook 189. In this state, when the operating lever 185 is turned toward the outer surface of the mounting band 173, the pivot of the operating lever 185 is displaced to the inside of the straight line X in the process of this turning movement. As a result, the direction of action of force of the operating lever 185 is reversed, and the operating lever 185 is self-locked. Specifically, the band fastener 181 of this embodiment is a self-locking fastener using a toggle mechanism, and the mounting band 173 can be securely tightened and fixedly mounted on the handle mounting part 115. This state is shown by solid line in FIG. 15. The lock can be released by turning the operating lever 185 away from the outer surface of the mounting band 173. In this state (shown by two-dot chain line A in FIG. 15), the position of the side handle 171 can be arbitrarily changed by turning the mounting band 173 around the longitudinal axis of the handle mounting part 115. Further, in the state in which the hook ring 187 is disengaged from the hook 189 as shown by two-dot chain line B in FIG. 15, the side handle 171 can be detached from the handle mounting part 115.

According to this embodiment, substantially the same effects as the above-described first embodiment can be obtained. For example, the position of the side handle 117 (the position of the grip part 131) can be easily adjusted to a desired position according to the operation. Further, particularly in this embodiment, by provision of the construction in which the mounting band 173 can be tightened and loosened by using the self-locking band fastener 181, the mounting band 173 can be easily tightened and loosened.

### Seventh Embodiment

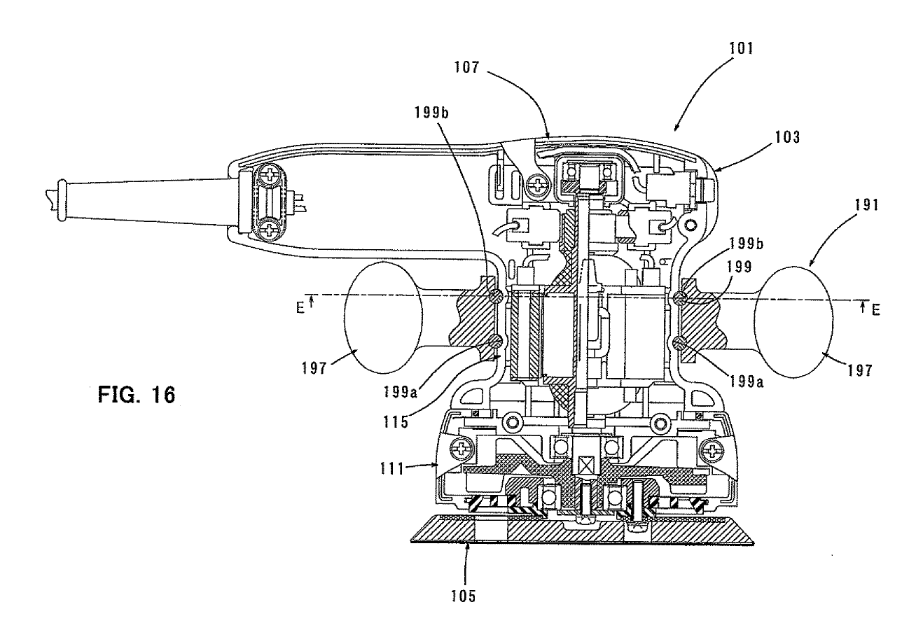

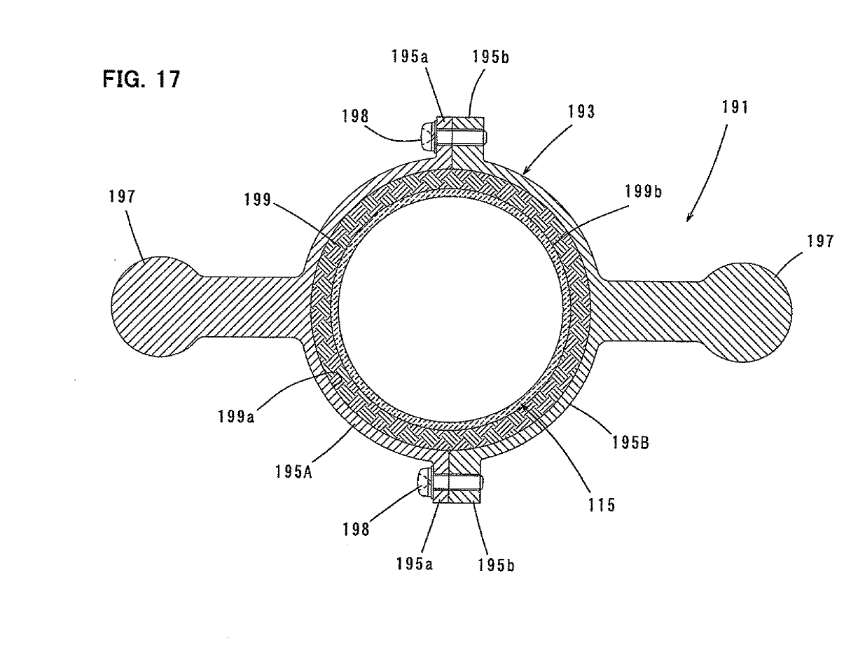

Now, a side handle according to a seventh embodiment of the invention is described with reference to FIGS. 16 and 17. A side handle 191 according to this embodiment mainly includes a ring-like mounting ring 193 which is attached to the handle mounting part 115 of the motor housing 103, and a grip part 197 to be held by a user. The side handle 191, the mounting ring 193 and the grip part 197 are features that correspond to the “movable handle”, the “ring” and the “grip”, respectively, according to this invention.

The mounting ring 193 includes a pair of ring components 195A, 195B which are opposed to each other and form a ring-like shape. Specifically, the ring components 195A, 195B are two semicircular halves of the mounting ring 193 in the circumferential direction. A grip part 197 is integrally formed with each of the ring components 195A, 195B and extends radially outward from the middle of the ring component in the circumferential direction. Connecting flanges 195a, 195b are formed on both ends of the ring components 195A, 195B in the circumferential direction and protrude radially outward.

In order to connect the ring components 195A, 195B, they are positioned to hold the handle mounting part 115 of the motor housing 103 from its both sides, and in this state, the connecting flanges 195a, 195b are fastened and connected together by fastening screws 198. In this state, the side handle 191 of this embodiment is provided as a straight handle having the two grip parts 197 arranged on a line on the outside of the mounting ring 193.

In the connected state, as shown in FIG. 16, a predetermined clearance is formed between the inner circumferential surfaces of the ring components 195A, 195B and the outer circumferential surface of the handle mounting part 115. Before the ring components 195A, 195B are fastened together, a plurality of O-rings 199 made of a flexible material such as rubber are disposed at predetermined intervals in the longitudinal direction between the inner circumferential surfaces of the ring components 195A, 195B and the outer circumferential surface of the handle mounting part 115. Each of the O-rings 199 is held by an O-ring groove 199a having a semicircular section and formed in the inner circumferential surfaces of the ring components 195A, 195B and an O-ring groove 199b having a semicircular section and formed in the outer circumferential surface of the handle mounting part 115.

In this embodiment, the mounting ring 193 is mounted on the handle mounting part 115 via the O-rings 199, and the mounting ring 193 is held by friction between the O-rings 199 and the O-ring grooves 199a on the side handle 191 side or the O-ring grooves 199b on the handle mounting part 115 side. Therefore, the position of the grip part 197 of the side handle 191 can be changed by turning the side handle 191 around the longitudinal axis of the handle mounting part 115 against the above-described friction. Specifically, each of the O-rings 199 is provided as a frictional member and is a feature that corresponds to the “frictional member” according to this invention. The friction can be adjusted by adjusting the force of fastening the ring components 195A, 195B by the fastening screws 198. Further, the frictional member is not limited to the O-ring 199, but any other frictional member may be used, or the frictional member may have a structure split in the circumferential direction.

According to this embodiment, substantially the same effects as the above-described first embodiment can be obtained. For example, the position of the side handle 191 (the position of the grip part 197) can be easily adjusted to a desired position according to the operation. Further, particularly in this embodiment, by using the O-rings 199 as a frictional member, transmission of vibration caused in the motor housing 103 during operation to the side handle 191 can be reduced, so that a vibration-proofing handle can be provided.

### Eighth Embodiment

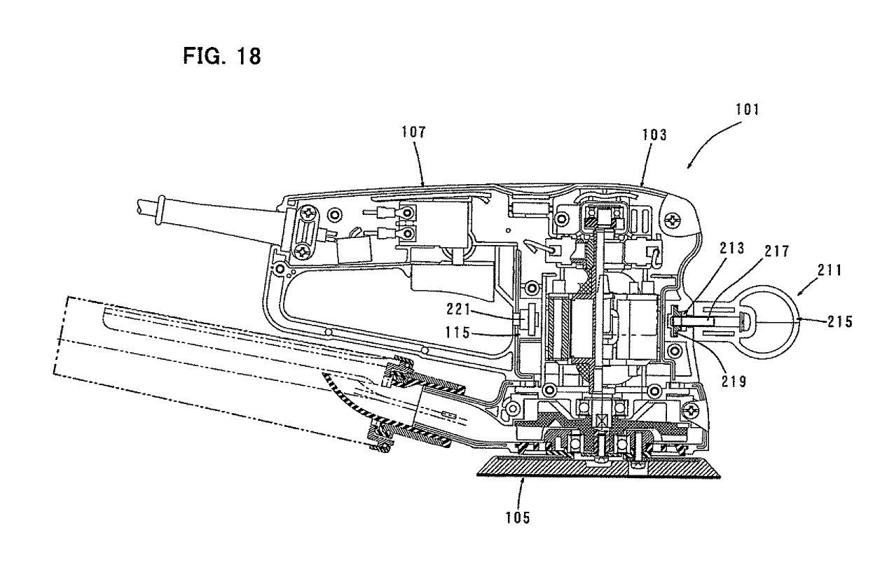

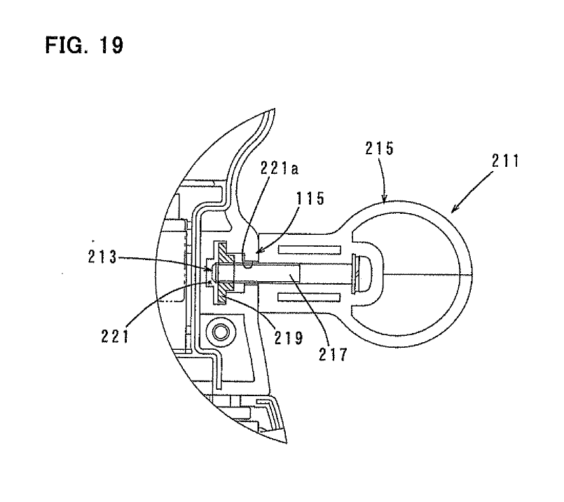

Now, a side handle according to an eighth embodiment of the invention is described with reference to FIGS. 18 and 19. A side handle 211 according to this embodiment mainly includes a cross-shaped mounting part 213 which is attached to the handle mounting part 115 of the motor housing 103, and a grip part 215 to be held by a user. The side handle 211 and the grip part 215 are features that correspond to the “movable handle” and the “grip”, respectively, according to this invention.

The cross-shaped mounting part 213 includes a threaded shaft 217 and a slide nut 219. The threaded shaft 217 is disposed within the grip part 215 and protrudes through one end surface of the grip part 215 in its longitudinal direction. The slide nut 219 is threadably mounted on the protruding end of the threaded shaft 217 and can slide within a slide guide groove 221 of the handle mounting part 115. The threaded shaft 217 and the slide nut 219 are features that correspond to the “adjusting member” and the “slider”, respectively, according to this invention. The threaded shaft 217 can be fixedly disposed within the grip part 215, for example, by forming the grip part 215 by two halves connected together, or by insert molding in the process of molding the grip part 215.

The slide guide groove 221 having a cross-shaped section is formed in the handle mounting part 115 of the motor housing 103 and extends in the circumferential direction. The slide nut 219 is disposed within the slide guide groove 221. By provision of the motor housing 103 formed by two halves connected together, the slide nut 219 can be disposed within the slide guide groove 221 before connecting the two halves. Further, the slide guide groove 221 having a cross-shaped section is open at an opening 221a all around the outer circumferential surface of the handle mounting part 115. The threaded shaft 217 of the grip part 215 is threadably engaged through the slide nut 219 within the slide guide groove 221 via the opening 221a. The slide guide groove 221 is a feature that corresponds to the “guide groove” according to this invention.

Therefore, when the grip part 215 is turned in one direction around its axis, the slide nut 219 moves toward the grip part 215 with respect to the threaded shaft 217. As a result, the end surface of the grip part 215 is pressed against the outer surface of the handle mounting part 115, and a surface of the slide nut 219 which faces the end surface of the grip part is pressed against the inner wall surface of the slide guide groove 221. Specifically, the handle mounting part 115 is clamped by the grip part 215 and the slide nut 219 in the radial direction from outside and inside, so that the side handle 211 is fixed to the handle mounting part 115. When the grip part 215 is turned in the opposite direction, the clamping of the grip part 215 and the slide nut 219 is released. In the released state, the position of the grip part 215 can be changed by sliding the slide nut 219 along the slide guide groove 221.

According to this embodiment, substantially the same effects as the above-described first embodiment can be obtained. For example, the position of the side handle 211 (the position of the grip part 215) can be easily adjusted to a desired position according to the operation.

In the above-described embodiments, the main handle in the form of the grip 107 and the movable handle in the form of the side handle 117, 141, 161, 171, 191 or 211 are described as being formed on the motor housing 103, but it is only necessary to provide at least the movable handle in the form of the side handle 117, 141, 161, 171, 191 or 211.

Further, in the above-described embodiments, the grip 107 is described as being formed as a fixed handle in the upper region of the motor housing 103, but the grip 107 may be a movable handle. Specifically, the sander 101 may have two movable handles which can be individually turned around the same axis or different axes with respect to the motor housing 103 and are arranged one above the other on the motor housing 103 in the direction of its central axis.

Further, the above-described embodiments are described as being applied to a sander for performing abrasive operation by using an abrasive sheet of cloth or paper coated with an abrasive, but they may also be applied to a tool for waxing or polishing by using a pad.

Further, according to the invention, following aspect can be provided:

### (Aspect 1)

“The sander as defined in claim 4, wherein the band includes a pair of semicircular arc band components each having one end rotatably connected to one end of the other and each having the other free end, and wherein a base is formed on the free end of each of the band components and the band is fixed on the surface of the cylindrical part of the cylindrical housing when the bases are clamped.”

### (Aspect 2)

“The sander as defined in (Aspect 1), wherein an outer surface of the base of each of the band components has a tapered surface, and the grip has a clamping tapered hole which is fitted on the tapered surface of the base, and the clamping tapered hole clamps the base and releases the clamping by movement of the grip in its longitudinal direction.”

### (Aspect 3)

“The sander as defined in (Aspect 2), wherein the grip and the band are connected to each other by a screw, and the grip is moved in its longitudinal direction via the screw when the grip is turned around its longitudinal axis,”

### (Aspect 4)

“The sander as defined in any one of claims 1 to 3, wherein the movable handle includes a band which has a pair of semicircular arc band components each having one end rotatably connected to one end of the other and each having the other free end, a clamping part which has a bolt and a nut threadably engaged with the bolt and fixes the band on the surface of the cylindrical part of the cylindrical housing by clamping the free ends in a direction toward each other and releases the fixing of the band on the cylindrical housing by releasing the clamping of the free ends, and a grip to be held by a user, and wherein one of the bolt and the nut of the clamping part is provided on the grip and the clamping part can be turned by the grip.”

### (Aspect 5)

“The sander as defined in any one of claims 1 to 3, wherein:

the movable handle includes a band which has a pair of semicircular arc band components each having one end rotatably connected to one end of the other and each having the other free end, a band fastener which is provided on the free ends and fixes the band on the surface of the cylindrical part of the cylindrical housing by clamping the free ends in a direction toward each other and releases the fixing of the band on the cylindrical housing by releasing the clamping of the free ends, and a grip connected to the band and designed to be held by a user, and

the band fastener includes an operating member which is mounted to the free end of the one band component and can be turned around a mounting point of the free end, and a hook member which is rotatably connected to the operating member at a position displaced from the mounting point and can be engaged with and disengaged from a hook of the other band component, wherein, when the operating member is turned with the hook member engaged with the hook, a pivot of the operating member is displaced across a straight line connecting a point of engagement of the hook member with the hook and a point of connection of the hook member with the operating member, whereby the band is fixed on the cylindrical housing or the fixing is released.”

### (Aspect 6)

“The sander as defined in any one of claims 1 to 3, wherein:

the band can move with respect to the cylindrical housing in the longitudinal direction, a plurality of projections are formed equidistantly in a circumferential direction on one of an inner circumferential surface of the band and an outer circumferential surface of the cylindrical housing, and a plurality of recesses are formed on the other of the inner circumferential surface of the band and the outer circumferential surface of the cylindrical housing at the same intervals as the projections in its circumferential direction and can be engaged with and disengaged from the projections by relative movement with respect to the cylindrical housing in a longitudinal direction of the band.”

### (Aspect 7)

The sander as defined in any one of claims 1 to 3, wherein the movable handle includes a ring that is disposed on the cylindrical housing and can rotate around the central axis of the cylindrical housing, a grip that is connected to an outer surface of the ring and designed to be held by the user, and a frictional member that is disposed between the inner circumferential surface of the ring and the outer circumferential surface of the cylindrical housing, and the position of the movable handle can be changed by turning the ring in the circumferential direction against friction between the frictional member and the ring or friction between the frictional member and the cylindrical housing.”

### (Aspect 8)

“The sander as defined in any one of claims 1 to 3, wherein the cylindrical housing has a guide groove open to its outer surface and extending continuously in the circumferential direction, and the movable handle includes a slider that is fitted in the guide groove and can move in the circumferential direction, and an adjusting member that locks the slider against movement with respect to the guide groove by pressing the slider against an inner wall surface of the guide groove and releases the lock by releasing the press of the slider against the inner wall surface of the guide groove.”

### DESCRIPTION OF NUMERALS

101 sander
103 motor housing (cylindrical housing)
105 abrasive part
107 grip (main handle)
107a first grip part
107b second grip part
109 trigger switch
111 lower housing
113 dust discharge nozzle
115 handle mounting part
117 side handle (movable handle)
121 mounting band (band)
123A band component
123B band component
123a base (clamping part)
123b base (clamping part)
125 pin
127 male threaded part (clamping operation part)
131 grip part (grip)
133 clamping tapered hole (clamping part)
135 female threaded part (clamping operation part)
137 projection
139 recess
141 side handle (movable handle)
143 mounting band (band)
145A band component
145B band component
145a base (clamping part)
145b base (clamping part)
146 pin
147 grip part (grip)
147a stepped through hole
148 clamping tapered hole
151 nut
153 bolt
161 side handle (movable handle)
163 mounting band (band)
165A band component
165B band component
165a base (clamping part)
165b base (clamping part)
166 pin
167 grip part (grip)
167a stepped through hole
167b end surface
168 bolt
169 nut
171 side handle (movable handle)
173 mounting band (band)
175A band component
175B band component
175a threaded shaft
176 pin
177 grip part (grip)
177a threaded hole
181 band fastener
183 shaft
185 operating lever (operating member)
187 hook ring (hook member)
187a connection point
187b engagement point
189 hook
191 side handle (movable handle)
193 mounting ring
195A ring component
195B ring component
195a connecting flange
195b connecting flange
197 grip part (grip)
199 O-ring (frictional member)
199a O-ring groove
199b O-ring groove
211 side handle (movable handle)
213 cross-shaped mounting part
215 grip part (grip)
217 threaded shaft
219 slide nut
221 slide guide groove
221a opening

1. A sander comprising:
a rotary working surface,
a driving mechanism that is disposed above the rotary working surface in a direction of a rotation axis of the rotary working surface and rotationally drives the rotary working surface,
a cylindrical housing that houses the driving mechanism, and
a movable handle that is mounted on a surface of a cylindrical part of the cylindrical housing, wherein the movable handle is turnable around a central axis of the cylindrical housing to be fixed at an arbitrary position in a circumferential direction of the cylindrical housing.

2. The sander as defined in claim 1, further comprising a second handle which is provided in addition to the movable handle, the second handle being rotatable with respect to the movable handle.

3. The sander as defined in claim 2, wherein the second handle is a fixed handle mounted on the cylindrical housing.

4. The sander as defined in claim 1, wherein the movable handle includes a band wrapped around the surface of the cylindrical part of the cylindrical housing, a clamping part that clamps the band, a clamping operation part that is operated to clamp the clamping part and to release the clamping, and a grip to be held by user's hand, and wherein the clamping operation part is operated to clamp the clamping part and to release the clamping when the user holds the grip by hand and turns the grip around its longitudinal axis.

5. The sander as defined in claim 4, wherein the band includes a pair of semicircular arc band components each having one end rotatably connected to one end of the other and each having the other free end, and wherein a base is formed on the free end of each of the band components and the band is fixed on the surface of the cylindrical part of the cylindrical housing when the bases are clamped.

6. The sander as defined in claim 5, wherein an outer surface of the base of each of the band components has a tapered surface, and the grip has a clamping tapered hole which is fitted on the tapered surface of the base, and the clamping tapered hole clamps the base and releases the clamping by movement of the grip in its longitudinal direction.

7. The sander as defined in claim 6, wherein the grip and the band are connected to each other by a screw, and the grip is moved in its longitudinal direction via the screw when the grip is turned around its longitudinal axis.

8. The sander as defined in claim 1, wherein the movable handle includes a band which has a pair of semicircular arc band components each having one end rotatably connected to one end of the other and each having the other free end, a clamping part which has a bolt and a nut threadably engaged with the bolt and fixes the band on the surface of the cylindrical part of the cylindrical housing by clamping the free ends in a direction toward each other and releases the fixing of the band on the cylindrical housing by releasing the clamping of the free ends, and a grip to be held by a user, and wherein one of the bolt and the nut of the clamping part is provided on the grip and the clamping part can be turned by the grip.

9. The sander as defined in claim 1, wherein:
the movable handle includes a band which has a pair of semicircular arc band components each having one end rotatably connected to one end of the other and each having the other free end, a band fastener which is provided on the free ends and fixes the band on the surface of the cylindrical part of the cylindrical housing by clamping the free ends in a direction toward each other and releases the fixing of the band on the cylindrical housing by releasing the clamping of the free ends, and a grip connected to the band and designed to be held by a user, and
the band fastener includes an operating member which is mounted to the free end of the one band component and can be turned around a mounting point of the free end, and a hook member which is rotatably connected to the operating member at a position displaced from the mounting point and can be engaged with and disengaged from a hook of the other band component, wherein, when the operating member is turned with the hook member engaged with the hook, a pivot of the operating member is displaced across a straight line connecting a point of engagement of the hook member with the hook and a point of connection of the hook member with the operating member, whereby the band is fixed on the cylindrical housing or the fixing is released.

10. The sander as defined in claim 1, wherein:
the band can move with respect to the cylindrical housing in the longitudinal direction, a plurality of projections are formed equidistantly in a circumferential direction on one of an inner circumferential surface of the band and an outer circumferential surface of the cylindrical housing, and a plurality of recesses are formed on the other of the inner circumferential surface of the band and the outer circumferential surface of the cylindrical housing at the same intervals as the projections in its circumferential direction and can be engaged with and disengaged from the projections by relative movement with respect to the cylindrical housing in a longitudinal direction of the band.

11. The sander as defined in claim 1, wherein the movable handle includes a ring that is disposed on the cylindrical housing and can rotate around the central axis of the cylindrical housing, a grip that is connected to an outer surface of the ring and designed to be held by the user, and a frictional member that is disposed between the inner circumferential surface of the ring and the outer circumferential surface of the cylindrical housing, and the position of the movable handle can be changed by turning the ring in the circumferential direction against friction between the frictional member and the ring or friction between the frictional member and the cylindrical housing.

12. The sander as defined in claim 1, wherein the cylindrical housing has a guide groove open to its outer surface and extending continuously in the circumferential direction, and the movable handle includes a slider that is fitted in the guide groove and can move in the circumferential direction, and an adjusting member that locks the slider against movement with respect to the guide groove by pressing the slider against an inner wall surface of the guide groove and releases the lock by releasing the press of the slider against the inner wall surface of the guide groove.
